(19) United States
(12) Patent Application Publication
(10) Pub. No.: US 2025/0361988 A1
(43) Pub. Date: Nov. 27, 2025

(54) DEVICE AND METHOD FOR FILLING A TANK

(71) Applicant: SAETA GMBH & CO. KG, Ludwigslust (DE)

(72) Inventor: Oliver JOACHIM, Pinneberg (DE)

(21) Appl. No.: 19/214,988

(22) Filed: May 21, 2025

(30) Foreign Application Priority Data
May 22, 2024 (DE) 20 2024 102 620.9

(51) Int. Cl. F17C 13/04; F17C 5/02

(52) U.S. Cl. CPC F17C 13/04; F17C 5/02; F17C 2250/0626

(57) ABSTRACT

Device for filling a tank with a product, in particular a liquefied gas product, comprising an upper filling valve which can be arranged on a first filling line connecting a product reservoir to an upper filling opening of the tank, and a lower filling valve which can be arranged on a second filling line connecting the product reservoir to a lower filling opening of the tank, wherein the device comprises a control valve to which the tank pressure in the tank is applied as control quantity and which is connected to the upper filling valve via a first control line and to the lower filling valve via a second control line, wherein the control valve controls the upper filling valve and the lower filling valve for filling the tank in such a way that the tank pressure corresponds to a predetermined nominal value or nominal value range.

The invention relates to a device and a method for filling a tank with a product, in particular a liquefied gas product, comprising an upper filling valve which can be arranged on a first filling line connecting a product reservoir to an upper filling opening of the tank, and a lower filling valve which can be arranged on a second filling line connecting the product reservoir to a lower filling opening of the tank.

For example, cryogenically cooled gases such as LIN, LOX and LAR are stored in liquid form in tanks. The stored liquefied gas product is fed into subsequent production or supply processes. The liquefied gas product is often converted to the original gas phase, which requires the supply of energy, in particular heating. The supply of liquefied gas products to production or supply processes must be very constant and precise, especially because the respective technical process components only have very limited working ranges for economic or technical reasons.

An essential requirement in this respect is to keep the product pressure in the storage tank as constant as possible at all times, and this in every operating state of the tank. The pressure in tanks filled with a liquefied gas product is largely determined by the temperature of the gas phase in the tank. Even with very good insulation, the liquefied gas product heats up, which on the one hand increases the tank pressure and on the other hand may significantly change the tank pressure when filling the tank with a colder product. The removal of product from the tank regularly causes a drop in tank pressure, which must also be compensated for. Such Compensation is usually carried out using heat exchangers to supply energy to the stored product. Also for economic reasons, the heat exchangers are designed as precisely as possible for normal withdrawal capacities and therefore only have low excess capacity above a certain limit.

As already explained, filling the tank with a product, in particular a cold liquefied gas product, leads to a change in the tank pressure. Such tanks are therefore usually filled from the top and the bottom. If the tank is filled from the top, the tank pressure drops. If, on the other hand, the tank is filled from the bottom, the tank pressure increases. This applies at least as long as the filling speed is not so high that a fountain in the tank passes through the liquid phase into the gas phase and the gas phase cools down considerably as a result, which can lead to an overall drop in tank pressure.

For economic reasons and reason of environmental protection, particularly with regard to energy consumption and possible emissions from the supply chain, it is desirable to fill the tank from the top and bottom at the same time with minimal valve and pipe resistance. The ratio of the filling rate from the top to the filling rate from the bottom is usually set manually by an operator so that the tank pressure remains as constant as possible. The manual valve settings are made on the basis of the operator's observations, which are based on the reading of a pressure gauge and a marking of the tank with regard to a nominal working pressure. The operator must continuously monitor the tank pressure and regulate the product feed if necessary. At the same time, the operator must monitor and, if necessary, also operate a tank vehicle or the like containing the product reservoir and a line connection between the product reservoir and the tank.

This can lead to longer monitoring gaps in the various areas. This results in a considerable operator risk and, in practice, a constant occurrence of operator errors, which can lead to an undesirable change in tank pressure. This in turn can cause very considerable economic damage, for example due to a prolonged downtime of downstream production or supply processes or, in the medical sector, disruptions to a critical supply chain.

### SUMMARY

Based on the state of the art described above, the invention is therefore based on the task of providing a device and a method of the type mentioned at the beginning, with which economic damage or disruptions to the supply chain can be avoided in a simple and reliable manner when filling a tank with a product.

The invention solves the problem by means of the independent claims 1 and 19. Advantageous embodiments can be found in the dependent claims, the description and the figures.

For a device of the type mentioned at the beginning, the invention solves the task in that the device comprises a control valve to which the tank pressure in the tank is applied as a control quantity, and which is connected to the upper filling valve via a first control line and to the lower filling valve via a second control line, wherein the control valve controls the upper filling valve and the lower filling valve for filling the tank in such a way that the tank pressure corresponds to a predetermined nominal value or nominal value range.

The tank can be a stationary arranged storage tank. However, it can also be a mobile tank, for example on a tank vehicle. The product reservoir containing the product to be filled in the tank can be a mobile tank, for example on a tank vehicle. However, it can also be a stationary arranged storage tank. As explained, the tank for filling can be filled with a liquefied gas product, in particular a cryogenic liquefied gas product, such as LIN, LOX, LAR, LNG. Such a liquefied gas product is present in the tank in both liquid and gaseous phase. The tank can be a single-walled low-temperature or normal-temperature tank, in particular a liquefied gas tank, or a double-walled tank, in particular a liquefied gas tank, for example a cryogenic tank. The same applies to the product reservoir.

The device according to the invention comprises a control valve to which the tank pressure in the tank is applied as a control quantity during a filling process. The control valve is connected to the upper filling valve via a first control line and to the lower filling valve via a second control line, so that the control valve can control both the upper filling valve and the lower filling valve for filling the tank with the product. Controls with different filling cross-sections are possible, which are unblocked by the respective filling valve. Accordingly, the filling rate of the tank from the top and from the bottom can be set individually by the control valve. Of course, the control valve can also close the top filling valve and/or the bottom filling valve to completely interrupt filling.

The control valve according to the invention, which in particular forms a pilot valve, is particularly maintenance-free in the long term and is able to automatically and precisely maintain the tank pressure within a nominal working pressure range or, for example, to interrupt further filling as a protective function if a limit value of the tank pressure is exceeded. The control valve in particular controls the upper filling valve and the lower filling valve for filling the tank in such a way that the tank pressure corresponds to a predefined nominal value or nominal value range, in particular with a defined tolerance above and below a fixed nominal value. To define a permitted range around the nominal value, a control hysteresis can be specified, which can be in a range of plus/minus 0.5 bar, for example. This avoids the valves switching too frequently and thus an excessive need for a control medium, such as a control gas like control air.

Due to the inventive design, the control valve can control the upper and lower filling valve for filling from the top and bottom of the tank at the same time, if the tank pressure applied to the control valve as a control quantity is within the specified nominal value or nominal value range. In this way, the inflow is maximized by a minimal resistance. If the tank pressure exceeds the specified nominal value or nominal value range, the control valve can be set to fill the tank more from the top or only from the top by activating the upper and lower filling valves accordingly. This leads to a lowering of the tank pressure. If, on the other hand, the tank pressure is below the specified nominal value or nominal value range, the control valve can control the upper and lower filling valves in such a way that the tank is filled more from the bottom, for example exclusively from the bottom, which typically increases the tank pressure again. If the product is fed in too quickly, so that the tank pressure drops to quickly despite the product already being fed exclusively through the lower filling valve, the control valve can interrupt further filling of the tank. Further filling can then take place, for example, via an external signal line bypass, possibly with a reduced flow rate if the lower filling valve is equipped with an external limitation. It is also possible to only open a reduced bypass filling line from the bottom. The control valve automatically resumes normal control operation as soon as a minimum tank pressure is reached again.

It is also possible to add further switching points, for example to achieve an increasingly reduced filling from the bottom before the filling is switched off. This can be done either by means of a slightly open position detection of a valve area or a continuous reduction of the control medium, for example control air, with increasing differential pressure to a nominal working pressure.

If the tank pressure rises above a maximum pressure despite the product already being fed exclusively from the top, the control valve can also interrupt further filling from the top. The control valve can then automatically resume control operation as soon as the pressure falls below a maximum pressure again.

Overall, the invention makes it possible to avoid economic damage due to prolonged downtime of subsequent production or supply processes or disruptions to a critical supply chain, for example in the medical sector, in a reliable and simple manner by using the control valve to automatically control the upper and lower filling valve in such a way that the tank pressure does not leave a nominal value or nominal value range.

In a particularly practical embodiment, the control valve can pneumatically control the upper filling valve and the lower filling valve. This allows particularly reliable and fast control, possibly independent of a power supply or an external control pressure supply.

The tank pressure in the tank can also be applied to an intermediate tank, and a control pressure of the control valve for pneumatic actuation of the upper filling valve and the lower filling valve can be fed from the pressure in the intermediate tank. In principle, the control valve can be operated from an external pressure source, for example for compressed air, or alternatively with a supplied pre-stored tank gas phase. The control valve uses the control gas to control the upper and lower filling valves. In particular, if the tank pressure is used as the control gas for the control valve via the intermediate tank, the control valve can operate completely autonomously, in particular in addition to a power supply also with respect to an external pressure supply. This is particularly important for critical infrastructure, for example in the medical field, e.g. for supplying hospitals with gases such as LOX and LIN. A regulator can be provided to bring the pressure used as the control pressure, in particular the pressure provided from an external pressure source or the tank pressure, to a predetermined constant value for use as the control pressure.

According to a further embodiment, the tank pressure applied to the control valve actuates a control shaft of the control valve in axial direction, wherein two control elements are arranged on the control shaft, which actuate the upper filling valve and/or the lower filling valve for filling the tank depending on the axial position of the control shaft. The control elements can comprise control discs arranged on the control shaft. The control elements can form cams which, depending on the axial position of the control shaft, actuate, for example, pneumatic valves which in turn actuate the upper or lower filling valve for filling the tank. The control valve can thus comprise a cam control for actuating the filling valves. The aforementioned design makes it particularly easy to control the filling valves automatically.

According to a further embodiment, the control shaft has an external thread and the control elements have an internal thread that engages with the external thread, so that the control elements can be arranged on the control shaft in different axial positions thereof. This way, the control valve can be adapted to different nominal values or nominal value ranges. In particular, the switching points of the control valve can be variably adjusted using the integrated spindle function of the stem and the control elements.

According to a further embodiment, the tank pressure can actuate the control shaft via a control bellows which expands in the axial direction of the control shaft depending on the tank pressure. The elastic control bellows can be a metal bellows, preferably a stainless steel bellows. A control hysteresis or nominal value range can be specified via such a control bellows, for example. The use of a metal material, such as stainless steel, also has the advantage that such materials are permitted in corresponding pressure equipment and the design of the control valve is also distinguished by a high level of freedom from contamination risk.

According to a further embodiment, at least one section of the control shaft comprising the control elements can be arranged in a housing of the control valve. The housing can form a protective housing. Furthermore, a spring device exerting back pressure on the control bellows can be arranged between the control bellows and a section of the control shaft comprising the control elements. The spring device can be supported on the control bellows on the one hand and on the housing on the other. The spring device can be formed by a plurality of springs stacked into each other in a cascade. The control shaft can extend through the spring device to the control bellows. The spring device can also be a metal spring device, preferably a stainless steel spring device. The spring device exerting back pressure on the control bellows allows the control valve to be adjusted, in particular to regulate the tank pressure to a predetermined nominal value range. The design of the spring device using a plurality of spring stacked into each other or cascaded springs enables a particularly compact design in the axial direction. This offers a considerable advantage in the present applications. As the spring device can also be made of a metal material, for example stainless steel, the advantages explained above with regard to permissibility in pressure devices are achieved. The aforementioned embodiments also allow a design in which functional areas in contact with the product do not require static and dynamic seals, in particular by combining the flexible control bellows with the aforementioned spring device.

According to a further embodiment, an adjustment element can be arranged on a side of the spring device facing away from the control bellows, with which adjustment element a preload of the spring device can be adjusted. The adjustment element can comprise an adjustment screw with which the spring device can be compressed to adjust the preload. This integrated tensioning device allows the control valve to be set to the desired nominal value, in particular by an operator, and, if desired, to be secured against changes, for example, by means of a seal.

The device can also have a display device on which, for example, the set nominal value or nominal value range is displayed for an operator.

According to a further embodiment, the tank pressure can be applied to the control valve via a pressure measuring line, and a shut-off valve can be arranged in the pressure measuring line, with which the pressure measuring line can be shut off, and a test connection can be provided between the shut-off valve and the control valve, to which a setting pressure for setting the control valve can be applied. By means of this design, the pressure measuring line which connects the tank pressure to the control valve as a control quantity can be shut off so that a setting or calibration pressure for setting or calibrating the control valve can be applied via a test connection of the pressure measuring line. This way, the control valve can be calibrated or set to a specific nominal value or nominal value range independently of the tank and the tank pressure inside of it.

The invention also relates to a system comprising a tank to be filled with a product, in particular a liquefied gas product, and a product reservoir and a device according to the invention. In the system according to the invention, the upper and lower filling valves are arranged on the first and second filling lines, respectively. As already explained, the tank can be a stationary arranged storage tank and the product reservoir can be a tank arranged on a tank vehicle. However, a design is also possible in which the tank is a mobile tank, for example a tank arranged on a tank vehicle, and/or in which the product reservoir is a stationary arranged storage tank.

The invention also solves the problem by a method for filling a tank with a product, in particular a liquefied gas product, using a device or system according to the invention.

### BRIEF DESCRIPTION OF THE DRAWINGS

Examples of embodiments of the invention are explained in more detail below with reference to drawings. It shows schematically:

FIG. 1 a system according to the invention with a device according to the invention according to a first embodiment,

FIG. 2 a sectional view of a control valve of the device according to the invention, and

FIG. 3 a system according to the invention and a device according to the invention according to a second embodiment example.

### DETAILED DESCRIPTION

Unless otherwise specified, the same reference symbols in the figures denote the same objects.

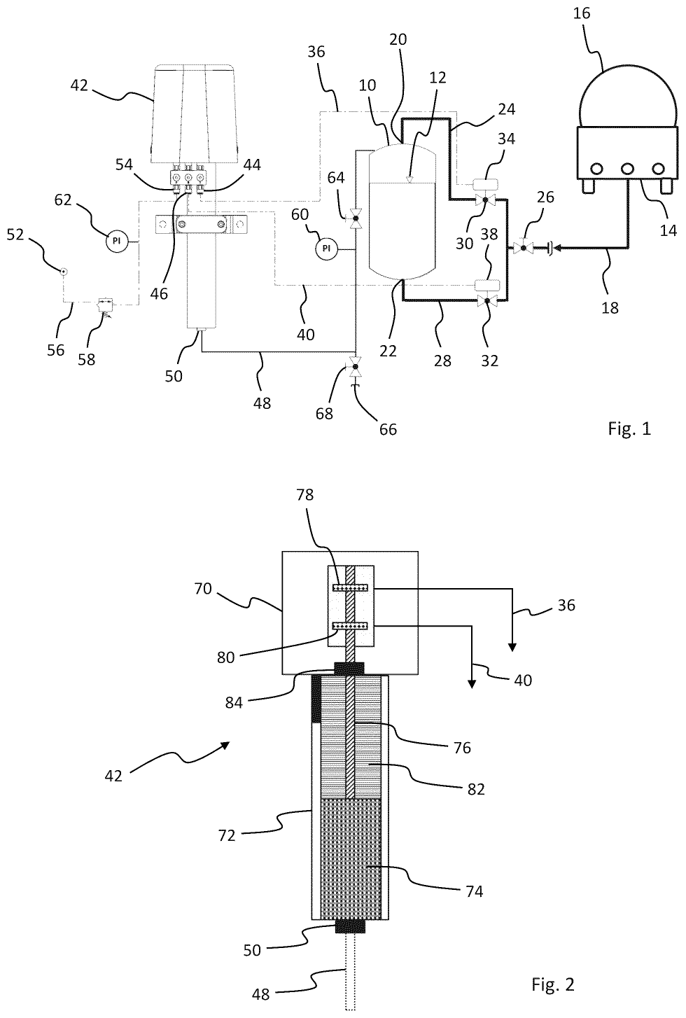

The system shown in FIG. 1 comprises a tank 10, in the present case a stationary storage tank 10, which is filled with a liquefied gas product which is contained in the storage tank 10 in the liquid state up to a liquid level 12 and above that in the gas phase. A tank vehicle 14 has a product reservoir 16 in the form of a mobile tank 16, from which further liquefied gas product is to be filled into the tank 10 via a supply line 18. For this purpose, the tank 10 comprises an upper filling opening 20 on its upper side and a lower filling opening 22 on its lower side.

A first filling line 24 connects the product reservoir 16 to the upper filling opening 20 via the supply line 18 and a shut-off valve 26, which, for example, is manually operated. A second filling line 28 also connects the product reservoir 16 to the lower filling opening 22 via the supply line 18 and the shut-off valve 26. An upper filling valve 30 is arranged on the first filling line 24 and a lower filling valve 32 is arranged on the second filling line 28. The upper filling valve 30 has a first pneumatic control inlet 34, to which a first control line 36 is connected, and the lower filling valve 32 has a second pneumatic control inlet 38, to which a second control line 40 is connected. By activating the upper filling valve 30 and the lower filling valve 32, the tank 10 can be filled with liquefied gas product from the product reservoir 16 via the upper filling opening 20 from the top and via the lower filling opening 22 from the bottom. For this purpose, the upper and lower filling valves 30, 32 open or close different flow cross-sections of the first and second filling lines 24, 28 respectively.

The system or device shown in FIG. 1 further comprises a control valve 42 with a first control outlet 44 connected to the first control line 36 and a second control outlet 46 connected to the second control line 40. The tank pressure in the tank 10 is present as a control quantity at a pressure inlet 50 of the control valve 42 via a pressure measuring line 48. As explained in more detail below, the control valve 42 controls the upper filling valve 30 and the lower filling valve 32 respectively for filling the tank 10 in such a way that the tank pressure corresponds to a predetermined nominal value or predetermined nominal value range. The control valve 42 does so based on the tank pressure which the control valve 42 receives as a control quantity via the first control line 36 and the second control line 40.

In the example shown in FIG. 1, the control pressure for pneumatic actuation of the upper filling valve 30 and the lower filling valve 32 via the first and second control inlet 34, 38 is provided by an external pressurized gas supply 52, in particular an compressed air supply 52. A regulator 58 is arranged in the control pressure line 56 connecting the pressurized gas supply 52 to the pressurized gas inlet 54 of the control valve 42, which regulates the control pressure to a predetermined value, for example 6 bar. A pressure gauge 60 (pressure indicator PI) is also arranged on the pressure measuring line 48. A corresponding pressure gauge 62 (PI) is also arranged on the control pressure line 56. The tank pressure measured by the pressure gauge 60 and/or the control pressure measured by the pressure gauge 62 can be displayed for an operator via a display device of the device according to the invention.

A shut-off valve 64 is also arranged in the pressure measuring line 48, via which the connection to the tank 10 can be shut off. A defined setting pressure can be applied to the control valve 42, in particular the pressure inlet 50, via a test connection 66 and a connection valve 68 in order to adjust the control valve 42, in particular to a desired nominal value or nominal value range.

FIG. 2 shows the control valve 42 in a sectional view. The control valve 42 comprises a housing 70, on the bottom of which an, for example, cylindrical connection housing 72 is arranged. The pressure inlet 50, to which the pressure measuring line 48 is connected, is located on the bottom of the connection housing 72. The tank pressure applied via the pressure measuring line 48 acts on an elastic control bellows 74, which is compressed depending on the tank pressure applied. A control shaft 76 is arranged on the upper side of the control bellows 74, the upper section of which projects into the housing 70. Two control discs 78, 80 forming cams are arranged axially spaced apart on the section of the control shaft 76 arranged in the housing 70. The control shaft 76 has an external thread at least in its upper section and the control discs 78, 80 have a corresponding internal thread, so that these can be arranged in different axial positions on the control shaft 76 in the manner of a spindle drive. When the control bellows 74 are expanded or compressed, the control shaft 76 is moved in the axial direction and with it the control discs 78, 80. These can, for example, actuate pneumatic valves not shown in more detail, which transmit the control pressure applied to the pressurized gas inlet 54 to the first control inlet 34 of the upper filling valve 30 or the second control inlet 38 of the lower filling valve 32, in particular via the first control line 36 and the second control line 40.

FIG. 2 also shows that the upper side of the control bellows 74 on the one hand and the bottom of the housing 70 on the other hand are supported by a spring device 82, formed in particular by springs stacked into each another in a cascade-like manner, which exerts a back pressure on the elastic control bellows 74. The amount of back pressure exerted by the spring device 82 can be adjusted by an adjustment element 84, for example an adjustment screw 84. Both the elastic control bellows 74 and the spring device 82 can be made of a metal material, for example stainless steel. This also applies to the other components of the control valve shown.

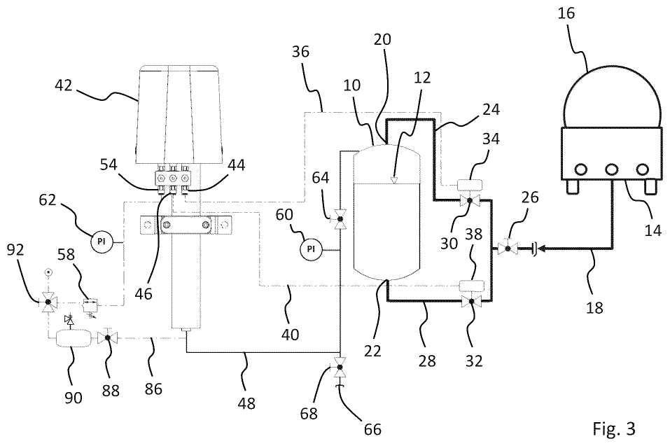

FIG. 3 shows a further embodiment of a system or device according to the invention, which largely corresponds to the embodiment example in FIG. 1.

In contrast to the embodiment shown in FIG. 1, the control pressure applied to the pressurized gas inlet 54 is provided via the tank pressure in the embodiment shown in FIG. 3. For this purpose, the tank pressure present in the pressure measuring line 48 is applied to an intermediate tank 90 via an intermediate tank line 86 and a shut-off valve 88. So, the control pressure present in the intermediate tank 90 is applied to the control pressure line 56 via a valve 92. The advantage of the embodiment shown in FIG. 3 is that the device according to the invention can operate autonomously, in particular autonomously from an external control pressure supply and a power supply.

### REFERENCE SIGNS

10 Tank
12 Liquid level
14 Tank vehicle
16 Product reservoir
18 Supply line
20 Upper filling opening
22 Lower filling opening
24 First filling line
26 Shut-off valve
28 Second filling lines
30 Upper filling valve
32 Lower filling valve
34 First control inlet
36 First control line
38 Second control inlet
40 Second control line
42 Control valve
44 First control outlet
46 Second control outlet
48 Pressure measuring line
50 Pressure inlet
52 Pressurized gas supply
54 Pressurized gas inlet
56 Control pressure line
58 Regulator
60 Pressure gauge
62 Pressure gauge
64 Shut-off valve
66 Test connection
68 Connection valve
70 Housing
72 Connection housing
74 Control bellows
76 Control shaft
78, 80 Control elements
82 Spring device
84 Adjustment element
86 Intermediate tank line
88 Shut-off valve
90 Intermediate tank
92 Valve

1. A device for filling a tank with a product, in particular a liquefied gas product, comprising an upper filling valve which can be arranged on a first filling line connecting a product reservoir to an upper filling opening of the tank, and a lower filling valve which can be arranged on a second filling line connecting the product reservoir to a lower filling opening of the tank, wherein that the device comprises a control valve to which the tank pressure in the tank is applied as control quantity and which is connected to the upper filling valve via a first control line and to the lower filling valve via a second control line, wherein the control valve controls the upper filling valve and the lower filling valve for filling the tank in such a way that the tank pressure corresponds to a predetermined nominal value or nominal value range.

2. The device according to claim 1, wherein the control valve pneumatically controls the upper filling valve and the lower filling valve.

3. The device according to claim 2, wherein the tank pressure in the tank is also applied to an intermediate tank, and that a control pressure of the control valve for pneumatic actuation of the upper filling valve and the lower filling valve is fed from the pressure in the intermediate tank.

4. The device according to claim 1, wherein the tank pressure applied to the control valve actuates a control shaft of the control valve in axial direction, wherein two control elements are arranged on the control shaft, which control the upper filling valve and/or the lower filling valve for filling the tank depending on the axial position of the control shaft.

5. The device according to claim 4, wherein the control elements comprise control discs arranged on the control shaft.

6. The device according to claim 4, wherein the control shaft has an external thread, and that the control elements have an internal thread engaging with the external thread, so that the control elements can be arranged on the control shaft in different axial positions thereof.

7. The device according to claim 4, wherein the tank pressure actuates the control shaft via a control bellows which expands in the axial direction of the control shaft depending on the tank pressure.

8. The device according to claim 7, wherein the control bellows is a metal bellows, preferably a stainless steel bellows.

9. The device according to claim 4, wherein at least a section of the control shaft comprising the control elements is arranged in a housing of the control valve.

10. The device according to claim 7, wherein a spring device exerting a back pressure on the control bellows is arranged between the control bellows and a section of the control shaft comprising the control elements.

11. The device according to claim 21, wherein the spring device is supported on the control bellows on the one hand and on the housing on the other hand.

12. The device according to claim 10, wherein the spring device comprises a plurality of springs stacked into each other.

13. The device according to claim 10, wherein the control shaft extends through the spring device to the control bellows.

14. The device according to claim 10, wherein the spring device is a metal spring device, preferably a stainless steel spring device.

15. The device according to claim 10, wherein an adjustment element is arranged on a side of the spring device facing away from the control bellows, with which adjustment element a preload of the spring device is adjustable.

16. The device according to claim 1, wherein the tank pressure is applied to the control valve via a pressure measuring line, and that a shut-off valve is arranged in the pressure measuring line, with which the pressure measuring line can be shut off, and that a test connection is provided between the shut-off valve and the control valve, to which a setting pressure for setting the control valve can be applied.

17. A system comprising a tank to be filled with a product, in particular a liquefied gas product, and a product reservoir and a device according to claim 1.

18. The system according to claim 17, wherein the tank is a stationary arranged storage tank, and that the product reservoir is a tank arranged on a tank vehicle.

19. A method for filling a tank with a product, in particular a liquefied gas product, using a device according to claim 1.

20. A method for filling a tank with a product, in particular a liquefied gas product using a system according to claim 17.

21. The device according to claim 9, wherein a spring device exerting a back pressure on the control bellows is arranged between the control bellows and a section of the control shaft comprising the control elements.
